(19) United States
(12) Patent Application Publication
(10) Pub. No.: US 2022/0410169 A1
(43) Pub. Date: Dec. 29, 2022

(54) WEAR-RESISTANT ELEMENT FOR A COMMINUTION DEVICE

(71) Applicants: thyssenkrupp Industrial Solutions AG, Essen (DE); thyssenkrupp AG, Essen (DE)

(72) Inventor: Baris IRMAK, Beckum (DE)

(73) Assignees: thyssenkrupp Industrial Solutions AG, Essen (DE); thyssenkrupp AG, Essen (DE)

(21) Appl. No.: 17/780,234

(22) PCT Filed: Nov. 25, 2020
(86) PCT No.: PCT/EP2020/083406

§ 371 Date: May 26, 2022

(30) Foreign Application Priority Data
Nov. 26, 2019 (BE) BE2019/5837
Nov. 26, 2019 (DE) 10 2019 218 217.8

(51) Int. Cl. B02C 4/30; B02C 15/00

(52) U.S. Cl. CPC B02C 4/305; B02C 15/005; B02C 2210/02

(57) ABSTRACT

A wear-resistant element is configured to be mounted on a comminuting device or a silo. The wear-resistant element may be formed from a ceramic that comprises yttrium-stabilized, tetragonal polycrystalline zirconia (TPZ). The TPZ makes up a proportion of the ceramic of at least 60% by volume, in some cases at least 80%, or even 95% to 100%. The ceramic may have a porosity of less than 5%. The ceramic may have a ratio of monoclinic to tetragonal zirconia of 10% to 40%. An yttrium-stabilized zirconia of the ceramic may have a grain size D50 of less than 1.5 μm. The ceramic may have an yttrium content of 2 to 4 mol % Y2O3.

The invention relates to a wear-resistant element for partially inserting into a recess in the surface of a wear area of a comminuting device, and to a comminuting device having such a wear-resistant element.

In comminuting devices, such as grinding rollers or crushers, which are used in particular in comminution of for example hard ore, a high level of wear of the surface of a wear area, for example the grinding-roller surface, occurs during operation of the comminuting device. In order to counteract this wear, it is known, for example from DE 2006 010 042 A1, to apply additional wear-resistant elements to the surface of the grinding roller. Given a certain degree of wear, it is necessary to replace or renovate the wear-resistant elements of the grinding roller, for example, in order to guarantee efficient grinding. Such a replacement is very expensive due to the frequency and the number of wear-resistant elements. The above-mentioned problem is also known from other technical fields, such as the storage of abrasive materials in a silo or bunker.

Therefore, it is an object of the present invention to provide a wear-resistant element which has a high level of wear resistance and at the same time is cost-effective to produce.

This object is achieved by a wear-resistant element having the features of independent device claim 1. Advantageous developments will become apparent from the dependent claims.

According to a first aspect, the invention comprises a wear-resistant element for mounting on a comminuting device or a silo, wherein the wear-resistant element is formed completely from a ceramic that comprises yttrium-stabilized, tetragonal polycrystalline zirconia (TPZ), wherein the TPZ makes up a proportion of the ceramic by volume of at least 60%, preferably at least 80%, in particular 95% to 100%.

The wear-resistant element has for example a cylindrical form or a square cross section. In particular, one end of the wear-resistant element is formed in such a way that it can be fastened to the surface of the wear area, in particular in a recess in the surface of the wear area.

The comminuting device is for example a roller mill, a roller crusher, a hammer mill or a vertical roller mill, wherein the wear area is in particular the surface of a grinding roller, the hammer tools and the surface of the grinding track of a hammer mill, or the surface of the rollers and of the grinding table of a vertical roller mill, which are subject to a high level of wear during operation of the comminuting device. It is likewise conceivable that the wear-resistant element has a plate-shaped form, for example, and is mounted on the inner wall of a store, in particular a silo for mineral rocks.

The wear-resistant element is formed completely from the ceramic. It is likewise conceivable that only part of the wear-resistant element, such as the region protruding from the surface of the comminuting device, is formed from the ceramic. For example, the wear-resistant element has a fastening region that is partially or completely fitted in the recess in the surface of the comminuting device and a wearing region that is completely or partially formed from the ceramic.

A wear-resistant element formed from yttrium-stabilized, tetragonal polycrystalline zirconia (TPZ) exhibits very favorable wear behavior together with high toughness. This is advantageous in particular when using such wear-resistant elements in comminuting devices.

According to a first embodiment, the ceramic has a porosity of less than 5%, preferably less than 4%, in particular less than 3%. The ceramic preferably has a porosity of at least 1%.

A porosity of less than 5%, preferably less than 4%, in particular less than 3%, results in improved wear behavior. The aforementioned porosity specification is preferably the total porosity, which corresponds to a mean average of the pore sizes of the material. The pores are preferably distributed substantially uniformly over the ceramic material.

By way of example, the ceramic has a density from 1.5 to 5 g/cm³, preferably 2 to 4 g/cm³, in particular 2.7 to 3 g/cm³. The ceramic comprises an Al2O3 (corundum) proportion of 10%, for example. This results in improved wear resistance combined with a slight reduction in the toughness of the ceramic.

According to a further embodiment, the ceramic has a ratio of monoclinic to tetragonal zirconia of less than 40%, in particular less than 30%, preferably less than 20%. The ratio of monoclinic to tetragonal zirconia is preferably at least 2%. By way of example, the zirconia incorporated in the ceramic comprises less than 40%, in particular less than 30%, preferably less than 20% monoclinic zirconia, the remaining zirconia being tetragonal zirconia. The ratio of monoclinic to tetragonal zirconia is determined by X-ray diffraction in accordance with ISO 13356, for example. At a ratio of more than 40%, preferably more than 30%, in particular more than 20% monoclinic to tetragonal and/or cubic zirconia, negative effects occur, such as for example metastable zirconia being converted to the stable monoclinic phase too quickly, with an increase in volume. If the conversion is too quick, surface tensions arise which generate local cracks, for example.

According to a further embodiment, the yttrium-stabilized zirconia of the ceramic has a grain size D50 of less than 1.5 μm, preferably less than 1 μm, in particular less than 0.8 μm. The D50 grain size of the ceramic is preferably at least 0.2 μm. The D50 value is to be understood to mean the grain size of 50% of the grains of the ceramic. In the case of the exemplary D50 grain size value, 50% of the grains of the yttrium-stabilized zirconia have a grain size diameter of less than 1.5 μm, preferably less than 1 μm, in particular less than 0.8 μm.

The D90 value of the grain size is preferably less than 3 μm, in particular less than 2 μm, preferably less than 1.5 μm. Wear-resistant elements of a comminuting device are exposed to local loading. A broad grain size distribution should therefore be avoided in order to prevent the formation of cracks or breakouts.

According to a further embodiment, the ceramic has an yttrium content of 2 to 4 mol % Y2O3. Advantages of such an yttrium content are better sintering behavior at an even lower sintering temperature, as well as a finer crystalline structure which in turn results in higher fatigue resistance and improved fracture toughness. Furthermore, the ceramic comprises Ce-TZP with a CeO2 content of 10-12 mol %, for example. In particular, the ceramic has an Mg-PSZ content of 8-10 mol %. It is likewise conceivable that the ceramic has an MgO content of 5-10 mol % as stabilizer.

According to a further embodiment, the number of pores in the ceramic that have a size of more than 200 μm is less than 0.1 per mm². The number of pores per area likewise provides an indication of the wear resistance. A small number of pores of relatively large size, such as more than 200 μm, ensures high wear resistance, because instances of local breakout from the ceramic material are avoided.

The number of pores in the ceramic that have a size of more than 150 μm is preferably less than 0.4 per mm². In particular, the number of pores in the ceramic that have a size of more than 100 μm is less than 2 per mm². Such a number of pores considerably increases the service life of the wear-resistant element.

The invention also includes a comminuting device having a wear area and a wear-resistant element as described above, wherein the wear-resistant element is mounted at least partially in a recess in the surface of the wear area. According to one embodiment, the wear-resistant element is bonded substance-to-substance, in particular welded, adhesively bonded or soldered, to the wear area.

The advantages described with regard to the wear-resistant element also apply to the comminuting device having such a wear-resistant element.

### DESCRIPTION OF THE DRAWINGS

The invention is explained in more detail in the following text on the basis of several exemplary embodiments with reference to the appended figures.

FIG. 1 shows a schematic illustration of a comminuting device in a front view according to one exemplary embodiment.

FIG. 2 shows a schematic illustration of a grinding roller of the comminuting device according to FIG. 1.

FIG. 3 shows schematic illustrations of an exemplary embodiment of the wear-resistant element in a sectional view.

FIG. 4 shows schematic illustrations of a further exemplary embodiment of the wear-resistant element in a sectional view.

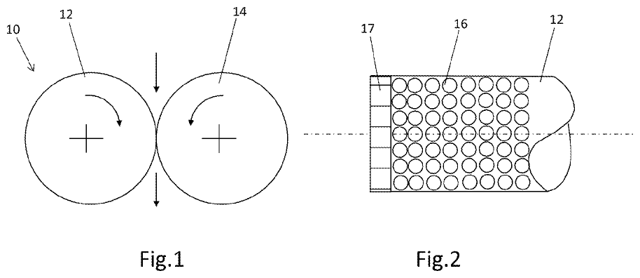

FIG. 1 schematically illustrates a comminuting device 10, in particular a roller mill. The comminuting device 10 comprises two grinding rollers, illustrated schematically as circles, having wear areas 12, 14 which have the same diameter and are arranged alongside one another. A grinding gap the size of which can be set, for example, is formed between the wear areas 12, 14 of the grinding rollers.

During operation of the comminuting device 10, the grinding rollers rotate in opposite directions to one another in directions of rotation illustrated by the arrows, wherein grinding stock passes through the grinding gap in the falling direction and is ground.

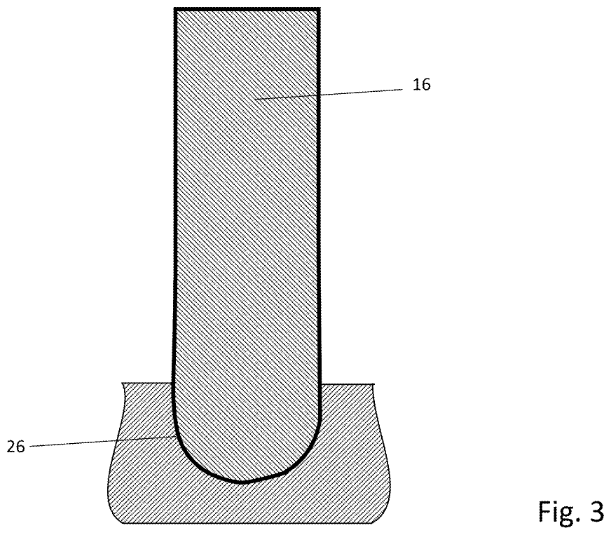

FIG. 2 shows an end region of a grinding roller which has a wear area 12, on which wear-resistant elements 16 are mounted. The wear-resistant elements 16 are mounted in the outer circumference of the surface of the grinding roller. For example, the mutually spaced-apart wear-resistant elements 16, arranged alongside one another, in FIG. 2 have a circular cross section. It is likewise conceivable for the wear-resistant elements 16 to vary in terms of size, number, cross-sectional shape and arrangement with respect to one another over the surface of the grinding roller, in order for example to compensate for local differences in wearing during operation of the comminuting device 10.

Furthermore, the grinding roller has wear-resistant corner elements 17, mounted on its end, which have for example a rectangular cross section and are arranged in a row alongside one another such that they form a ring around the circumference of the grinding roller. Further cross-sectional shapes of the wear-resistant corner elements 17, which differ from the cross-sectional shape shown in FIG. 2, are furthermore conceivable. A mutually spaced-apart arrangement of the wear-resistant corner elements 17 is also possible. In FIG. 2, by way of example, only the left-hand end of the grinding roller having the wear area 12 is shown, wherein the right-hand end, which is not shown, is advantageously of identical construction.

FIG. 3 shows a wear-resistant element 16 in a sectional view. By way of example, the wear-resistant element is cylindrical and is formed completely from a ceramic. The ceramic is yttrium-stabilized, tetragonal polycrystalline zirconia (TPZ), wherein the TPZ makes up a proportion of the ceramic by volume of at least 60%, preferably at least 80%, in particular 95% to 100%. The ceramic material offers the advantage of particularly high wear resistance while at the same time being relatively inexpensive to produce.

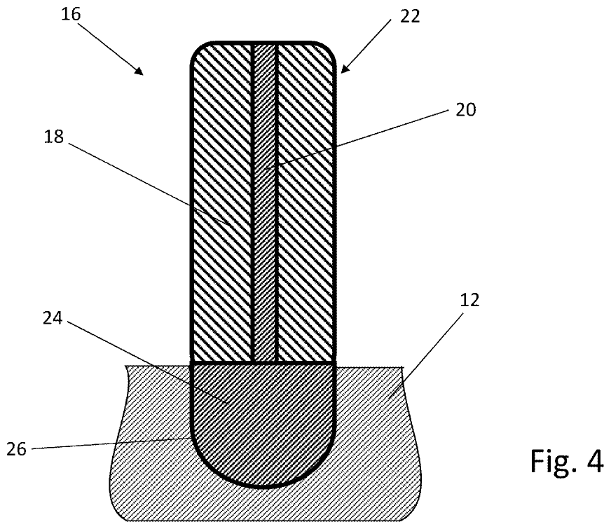

FIG. 4 shows a further exemplary embodiment, in which the wear-resistant element 16 has a shell 18 and a core 20 at least partially radially surrounded by the shell 18. The core 20 extends axially along the center axis of the substantially cylindrical wear-resistant element 16 to the upper end face of the wear-resistant element 16. The core 20 for example has a cylindrical form and is preferably fixedly connected to the shell 18. It is likewise conceivable that a plurality of cores 20, for example two, four or six cores 20, extend through the wear-resistant element 16, preferably parallel to one another. By way of example, the diameter of the core 20 is approximately 10 to 30% of the diameter of the wear-resistant element 16.

FIG. 4 shows a sectional view of the wear-resistant element 16 in FIG. 3. The wear-resistant element 16 has a fastening region 24 and a wearing region 22, wherein the fastening region 24 is arranged in the recess 26 in the surface of the wear area 12 of the grinding roller and is connected to the wear area 12 of the grinding roller. For example, on the fastening region 24, the wear-resistant element 16 is bonded substance-to-substance, in particular welded, soldered or adhesively bonded, or connected by a form fit, in particular screwed or wedged, to the recess 26 in the surface of the wear area 12 of the grinding roller. The wearing region 22 of the wear-resistant element 16 is arranged at least partially or completely outside the recess 26 in the wear area 12, with the result that said wearing region protrudes from the surface of the wear area 12 in a radial direction of the grinding roller (not illustrated). In the exemplary embodiment illustrated, the fastening region 24 comprises about one third of the entire wear-resistant element 16, the wearing region 22 comprising approximately the further two thirds. The fastening region 24 is preferably formed from a metal, such as for example steel.

The wearing region 22 of the wear-resistant element 16 comprises the shell 18 and the core 20, the jacket 18 preferably being formed from a ceramic material, such as for example tungsten carbide, titanium carbide, titanium carbonitride, vanadium carbide, chromium carbide, tantalum carbide, boron carbide, niobium carbide, molybdenum carbide, aluminum oxide, zirconia, and/or silicon carbide, or a combination of the stated materials. In particular, the ceramic comprises yttrium-stabilized, tetragonal polycrystalline zirconia (TPZ). Furthermore, it is also possible for particles of industrial diamonds or high-strength ceramics, for example, to be embedded in a ceramic or metallic matrix in the shell 18. The shell 18 comprises a matrix material, for example, in which a plurality of particles are arranged. The particles in question are in particular a highly wear-resistant material which comprises for example diamond, ceramic or titanium. The matrix material comprises for example tungsten carbide. The particles are bonded in particular substance-to-substance, for example by sintering with the matrix material.

During operation of the comminuting device 10, the wear-resistant elements 16 are exposed to a high degree of wear, wherein in particular the wearing region 22, protruding from the surface of the wear areas 12, 14 of the grinding rollers, of the wear-resistant elements 16 becomes worn. The wear-resistant material of the wearing region 22 considerably reduces the wear of the wear-resistant elements 16. Furthermore, it is possible to dispense with forming the fastening region, which is exposed to no wear or only to very little wear, from the more expensive, more wear-resistant material. The metal core makes it possible to remove the wear-resistant element from the recess 26 in the roll surface, even if the wearing region 22 is already severely worn, by using a suitable tool to draw the wear-resistant element 16 out on the metal core 20.

The fastening region 24 is preferably formed completely from a metal and is fixedly connected to the core 20. By way of example, the fastening region 24 is adhesively bonded, soldered or welded to or is formed in one piece with the core 20.

### LIST OF REFERENCE SIGNS

10 Comminuting device/roller mill

12 Wear surface/grinding roller

14 Wear surface/grinding roller

16 Wear-resistant element

17 Wear-resistant corner element

18 Shell

20 Core

22 Wearing region

24 Fastening region

26 Recess

1.-8. (canceled)

9. A wear-resistant element that is mountable on a comminuting device or a silo, wherein the wear-resistant element is formed completely from a ceramic that comprises yttrium-stabilized, tetragonal polycrystalline zirconia (TPZ), wherein the TPZ makes up at least 60% by volume of the ceramic.

10. The wear-resistant element of claim 9 wherein the ceramic has a porosity of less than 5%.

11. The wear-resistant element of claim 9 wherein the ceramic has a porosity of less than 3%.

12. The wear-resistant element of claim 9 wherein the ceramic has a ratio of monoclinic to tetragonal zirconia of 10% to 40%.

13. The wear-resistant element of claim 9 wherein the ceramic has a ratio of monoclinic to tetragonal zirconia of 10% to 20%.

14. The wear-resistant element of claim 9 wherein an yttrium-stabilized zirconia of the ceramic has a grain size D50 of less than 1.5 μm.

15. The wear-resistant element of claim 9 wherein an yttrium-stabilized zirconia of the ceramic has a grain size D50 of less than 1.0 μm.

16. The wear-resistant element of claim 9 wherein an yttrium-stabilized zirconia of the ceramic has a grain size D50 of less than 0.8 μm.

17. The wear-resistant element of claim 9 wherein the ceramic has an yttrium content of 2 to 4 mol % Y2O3.

18. The wear-resistant element of claim 9 wherein the ceramic has less than 0.1 per mm² of pores with a size of more than 200 μm.

19. A comminuting device comprising:
a wear area; and
a wear-resistant element that is mounted at least partially in a recess in a surface of the wear area, wherein the wear-resistant element is formed completely from a ceramic that comprises yttrium-stabilized, tetragonal polycrystalline zirconia (TPZ), wherein the TPZ makes up at least 60% by volume of the ceramic

20. The comminuting device of claim 19 wherein the wear-resistant element is bonded substance-to-substance to the wear area.

21. The comminuting device of claim 19 wherein the wear-resistant element is welded to the wear area.

22. The comminuting device of claim 19 wherein the wear-resistant element is adhesively bonded to the wear area.

23. The comminuting device of claim 19 wherein the wear-resistant element is soldered to the wear area.

24. The comminuting device of claim 19 wherein the ceramic has a porosity of less than 3%.

25. The comminuting device of claim 19 wherein the ceramic has a ratio of monoclinic to tetragonal zirconia of 10% to 20%.

26. The comminuting device of claim 19 wherein an yttrium-stabilized zirconia of the ceramic has a grain size D50 of less than 1.5 μm.

27. The comminuting device of claim 19 wherein the ceramic has an yttrium content of 2 to 4 mol % Y2O3.

28. The comminuting device of claim 19 wherein the ceramic has less than 0.1 per mm² of pores with a size of more than 200 μm.
